(19) United States
(12) Patent Application Publication
(10) Pub. No.: US 2010/0082364 A1
(43) Pub. Date: Apr. 1, 2010

(54) Medical Information Management

(75) Inventors: Marc B. Taub, Mountain View, CA (US); Nathan Crouther, San Francisco, CA (US)

Correspondence Address: JACKSON & CO., LLP, 6114 LA SALLE AVENUE, #507, OAKLAND, CA, 94611-2802, US

(73) Assignee: Abbott Diabetes Care, Inc., Alameda, CA (US)

(21) Appl. No.: 12/242,829

(22) Filed: Sep. 30, 2008

(51) Int. Cl. G06Q 50/00; H04L 9/06

(52) U.S. Cl. 705/2; 713/193

(57) ABSTRACT

Method and system for detecting a device connection, receiving device identification information, receiving a code based on a subject information and the location information, receiving glucose data over the detected device connection, and storing the received glucose data with a generated code in a predetermined file format are provided.

### TECHNICAL FIELD

The present disclosure relates to medical information management. More specifically, the present disclosure relates to medical data processing and/or communication in a managed data network.

### BACKGROUND

In diabetes management, glucose data analysis plays a significant role in therapy decisions and health management. Glucose level information are typically collected or stored over a set period of time and then analyzed or reviewed by a healthcare provider or the patient to determine adjustments, if any, to the on-going or new diabetes treatment regimen. Such analysis may display recurring excursions in glucose levels at certain times of the day or in response to certain types of meals or activity. Diabetic patients and/or healthcare provider may use such information to improve diabetes management.

Commercially available analysis tools such as computer programs are generally intended for use by diabetic patients and/or healthcare providers for purposes of analyzing his or her own glucose information (or that of healthcare providers' patients).

### SUMMARY

In accordance with the various embodiments of the present disclosure, there are provided method and system for detecting a device connection, receiving device identification information, receiving a generated code based on the subject identification information and the location information (for example, a site identifier used to specify particular locations participating in multi-center clinical studies), receiving glucose data over the detected device connection, and storing the received glucose data with a generated code in a predetermined file format are provided.

In another aspect, there is provided a data communication interface, one or more processors coupled to the data communication interface, and a memory storing instructions which, when executed by the one or more processors, detects a device connection, receives device identification information, receives a generated a code based on the subject identification information and the location information, receives glucose data over the detected device connection, and stores the received glucose data with a generated code in a predetermined file format.

These and other objects, features and advantages of the present disclosure will become more fully apparent from the following detailed description of the embodiments, the appended claims and the accompanying drawings.

### BRIEF DESCRIPTION OF THE DRAWINGS

FIG. 1 is a block diagram illustrating an overall system for practicing one or more embodiments of the present disclosure;

FIG. 2 is an example flowchart for data upload routine for use with the overall system of FIG. 1 in accordance with one embodiment of the present disclosure; and

FIG. 3 is an example flowchart for data upload routine for use with the overall system of FIG. 1 in accordance with another embodiment of the present disclosure.

### DETAILED DESCRIPTION

Before the present disclosure is described, it is to be understood that this invention is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present disclosure, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior invention. Further, the dates of publication provided may be different from the actual publication dates which may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

The figures shown herein are not necessarily drawn to scale, with some components and features being exaggerated for clarity.

Generally, embodiments of the present disclosure relate to methods and devices for detecting at least one analyte such as glucose in body fluid. In certain embodiments, the present disclosure relates to the continuous and/or automatic in vivo monitoring of the level of an analyte using an analyte sensor.

Accordingly, embodiments include analyte monitoring devices and systems that include an analyte sensor—at least a portion of which is positionable beneath the skin of the user—for the in vivo detection, of an analyte, such as glucose, lactate, and the like, in a body fluid. Embodiments include wholly implantable analyte sensors and analyte sensors in which only a portion of the sensor is positioned under the skin and a portion of the sensor resides above the skin, e.g., for contact to a transmitter, receiver, transceiver, processor, etc. The sensor may be, for example, subcutaneously positionable in a patient for the continuous or periodic monitoring of a level of an analyte in a patient's interstitial fluid. For the purposes of this description, continuous monitoring and periodic monitoring will be used interchangeably, unless noted otherwise. The analyte level may be correlated and/or converted to analyte levels in blood or other fluids. In certain embodiments, an analyte sensor may be positioned in contact with interstitial fluid to detect the level of glucose, which detected glucose may be used to infer the glucose level in the patient's bloodstream. Analyte sensors may be insertable into a vein, artery, or other portion of the body containing fluid. Embodiments of the analyte sensors of the subject invention may be configured for monitoring the level of the analyte over a time period which may range from minutes, hours, days, weeks, or longer.

Of interest are analyte sensors, such as glucose sensors, that are capable of in vivo detection of an analyte for about one hour or more, e.g., about a few hours or more, e.g., about a few days of more, e.g., about three or more days, e.g., about five days or more, e.g., about seven days or more, e.g., about several weeks or at least one month. Future analyte levels may be predicted based on information obtained, e.g., the current analyte level at time t₀, the rate of change of the analyte, etc. Predictive alarms may notify the user of predicted analyte levels that may be of concern prior in advance of the analyte level reaching the future level. This enables the user an opportunity to take corrective action.

As described in detail below, in accordance with the various embodiments of the present disclosure, there are provided medical information management system including, diabetes data analysis and processing tools. More particularly, in accordance with the various embodiments of the present disclosure, diabetes information management tools are provided for use in clinical studies and diabetes therapy related research and analysis.

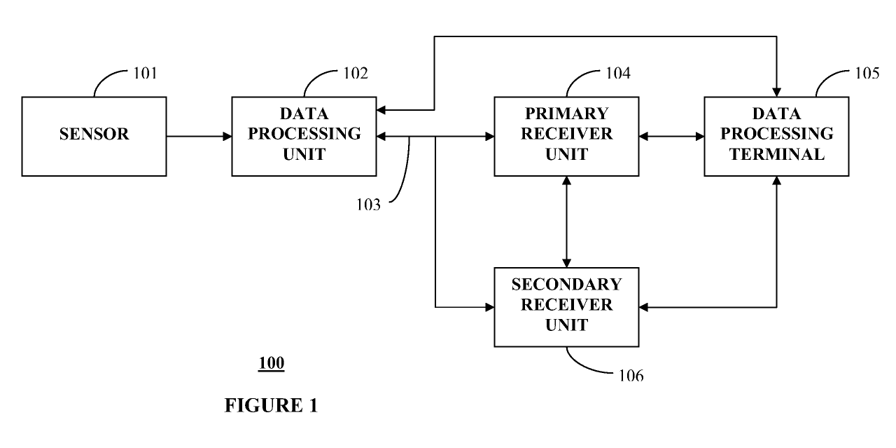

FIG. 1 shows a data monitoring and management system such as, for example, an analyte (e.g., glucose) monitoring system 100 in accordance with certain embodiments. Embodiments of the subject invention are further described primarily with respect to glucose monitoring devices and systems, and methods of glucose detection, for convenience only and such description is in no way intended to limit the scope of the invention. It is to be understood that the analyte monitoring system may be configured to monitor a variety of analytes at the same time or at different times.

Analytes that may be monitored include, but are not limited to, acetyl choline, amylase, bilirubin, cholesterol, chorionic gonadotropin, creatine kinase (e.g., CK-MB), creatine, DNA, fructosamine, glucose, glutamine, growth hormones, hormones, ketones, lactate, peroxide, prostate-specific antigen, prothrombin, RNA, thyroid stimulating hormone, and troponin. The concentration of drugs, such as, for example, antibiotics (e.g., gentamicin, vancomycin, and the like), digitoxin, digoxin, drugs of abuse, theophylline, and warfarin, may also be monitored. In those embodiments that monitor more than one analyte, the analytes may be monitored at the same or different times.

The analyte monitoring system 100 in one embodiment includes a sensor 101, a data processing unit 102 connectable to the sensor 101, and a primary receiver unit 104 which is configured to communicate with the data processing unit 102 via a communication link 103. In certain embodiments, the primary receiver unit 104 may be further configured to transmit data to a data processing terminal 105 to evaluate or otherwise process or format data received by the primary receiver unit 104. The data processing terminal 105 may be configured to receive data directly from the data processing unit 102 via a communication link which may optionally be configured for bi-directional communication. Further, the data processing unit 102 may include a transmitter or a transceiver to transmit and/or receive data to and/or from the primary receiver unit 104, the data processing terminal 105 or optionally the secondary receiver unit 106.

Also shown in FIG. 1 is an optional secondary receiver unit 106 which is operatively coupled to the communication link and configured to receive data transmitted from the data processing unit 102. The secondary receiver unit 106 may be configured to communicate with the primary receiver unit 104, as well as the data processing terminal 105. The secondary receiver unit 106 may be configured for bi-directional wireless communication with each of the primary receiver unit 104 and the data processing terminal 105. As discussed in further detail below, in certain embodiments the secondary receiver unit 106 may be a de-featured receiver as compared to the primary receiver, i.e., the secondary receiver may include a limited or minimal number of functions and features as compared with the primary receiver unit 104. As such, the secondary receiver unit 106 may include a smaller (in one or more, including all, dimensions), compact housing or embodied in a device such as a wrist watch, arm band, etc., for example. Alternatively, the secondary receiver unit 106 may be configured with the same or substantially similar functions and features as the primary receiver unit 104. The secondary receiver unit 106 may include a docking portion to be mated with a docking cradle unit for placement by, e.g., the bedside for night time monitoring, and/or bi-directional communication device.

Only one sensor 101, data processing unit 102 and data processing terminal 105 are shown in the embodiment of the analyte monitoring system 100 illustrated in FIG. 1. However, it will be appreciated by one of ordinary skill in the art that the analyte monitoring system 100 may include more than one sensor 101 and/or more than one data processing unit 102, and/or more than one data processing terminal 105. Multiple sensors may be positioned in a patient for analyte monitoring at the same or different times. In certain embodiments, analyte information obtained by a first positioned sensor may be employed as a comparison to analyte information obtained by a second sensor. This may be useful to confirm or validate analyte information obtained from one or both of the sensors. Such redundancy may be useful if analyte information is contemplated in critical therapy-related decisions. In certain embodiments, a first sensor may be used to calibrate a second sensor.

The analyte monitoring system 100 may be a continuous monitoring system, or semi-continuous, or a discrete monitoring system. In a multi-component environment, each component may be configured to be uniquely identified by one or more of the other components in the system so that communication conflict may be readily resolved between the various components within the analyte monitoring system 100. For example, unique identification codes (IDs), communication channels, and the like, may be used.

In certain embodiments, the sensor 101 is physically positioned in or on the body of a user whose analyte level is being monitored. The sensor 101 may be configured to at least periodically sample the analyte level of the user and convert the sampled analyte level into a corresponding signal for transmission by the data processing unit 102. The data processing unit 102 is coupleable to the sensor 101 so that both devices are positioned in or on the user's body, with at least a portion of the analyte sensor 101 positioned transcutaneously. The data processing unit 102 performs data processing functions, where such functions may include but are not limited to, filtering and encoding of data signals, each of which corresponds to a sampled analyte level of the user, for transmission to the primary receiver unit 104 via the communication link 103. In one embodiment, the sensor 101 or the data processing unit 102 or a combined sensor/data processing unit may be wholly implantable under the skin layer of the user.

In one aspect, the primary receiver unit 104 may include an analog interface section including and RF receiver and an antenna that is configured to communicate with the data processing unit 102 via the communication link 103, data processing unit 102 and a data processing section for processing the received data from the data processing unit 102 such as data decoding, error detection and correction, data clock generation, and/or data bit recovery.

In operation, the primary receiver unit 104 in certain embodiments is configured to synchronize with the data processing unit 102 to uniquely identify the data processing unit 102, based on, for example, an identification information of the data processing unit 102, and thereafter, to periodically receive signals transmitted from the data processing unit 102 associated with the monitored analyte levels detected by the sensor 101.

Exemplary analyte systems that may be employed are described in, for example, U.S. Pat. Nos. 6,134,461, 6,175,752, 6,121,611, 6,560,471, 6,746,582, and in application Ser. No. 10/745,878 filed Dec. 26, 2003 entitled “Continuous Glucose Monitoring System and Methods of Use”, the disclosures of each of which are herein incorporated by reference.

Referring again to FIG. 1, the data processing terminal 105 may include a personal computer, a portable computer such as a laptop or a handheld device (e.g., personal digital assistants (PDAs), telephone such as a cellular phone (e.g., a multimedia and Internet-enabled mobile phone such as an iPhone, Palm® device, Blackberry® device or similar device), mp3 player, pager, and the like), drug delivery device, each of which may be configured for data communication with the receiver via a wired or a wireless connection. Additionally, the data processing terminal 105 may further be connected to a data network (not shown) for additionally storing, retrieving, updating, and/or analyzing data corresponding to the detected analyte level of the user as described in further detail below.

In certain embodiments, the communication link 103 as well as one or more of the other communication interfaces shown in FIG. 1 to communicate data between the data processing unit 102, the primary receiver unit 104, secondary receiver unit 106 and the data processing terminal 105 may use one or more of an RF communication protocol, an infrared communication protocol, a Bluetooth enabled communication protocol, an 802.11x wireless communication protocol, or an equivalent wireless communication protocol which would allow secure, wireless communication of several units (for example, per HIPPA requirements) while avoiding potential data collision and interference.

Furthermore, data communication between the primary receiver unit 104 and the data processing terminal 105, or between the secondary receiver unit 106 and the data processing terminal 105 may include wireless or wired connection such as USB connection, RS-232 connection, serial connection, and the like, to transfer data between the one or more of the primary and the secondary receiver units 104, 106 to the data processing terminal 105.

In one aspect, the analyte monitoring system 100 may be used in clinical or investigation studies or in therapy research and development where subjects or patients may use the analyte monitoring system 100 to monitor their glucose levels for a predetermined time period, and upon collection of the glucose data over the predetermined time period, the collected data is retrieved from each subject's analyte monitoring system and thereafter, processed or further analyzed. That is, in one aspect, healthcare or pharmaceutical companies may use the analyte monitoring system 100 with a defined set of subjects to perform clinical studies and/or therapy related research. In such cases, it is important to maintain accuracy and integrity of the collected data from each subject using the analyte monitoring system.

For example, in the development of diabetes therapy, clinical studies or investigation or research conducted based on monitored glucose levels of subjects may involve a large number of subjects using the analyte monitoring system for a given time period. At the conclusion of the time period, the collected data is retrieved from each subject and thereafter further analyzed or processed. In such studies, investigation or research may employ hundreds of study or research subjects, each using a separate analyte monitoring system. Given a large number of subject pool and the corresponding analyte monitoring systems, it is important to maintain the accuracy of the collected glucose related data for each subject. Accordingly, as described in further detail below, in particular embodiments, functionalities are provided in computer software environment to collect the large amount of data from each of the analyte monitoring system which is customizable for the particular study or research in progress, and which provide data processing, analysis, transfer, or communication in a secure manner.

Referring back to FIG. 1, in particular embodiments, at a clinical study or research may include multiple investigation sites (each of which may be at geographically separate location), and where each investigation site may include a predetermined number of subjects to conduct the investigation. The subjects at each investigation site may be instructed to use the analyte monitoring system including the sensor 101, data processing unit 102 and primary receiver unit 104 for a predetermined time period (for example, 30 days) that would be useful for the investigation. During this time period, each subject using the analyte monitoring system collects and stores the monitored glucose levels detected by the analyte sensor 101 and transmitted to the receiver unit 104 by the data processing unit 102.

The receiver unit 104 may be configured to store the received glucose related data for the defined time period. At the conclusion of the predetermined time period, each receiver unit 104 of each subject at the respective investigation site may transfer the stored glucose related data to a computer terminal or a server terminal located, for example, at the investigation site. The data transfer may be optionally performed remotely via a wired or wireless connection through the data processing terminal 105 which may be configured to receive the stored glucose related data from the receiver unit 104 upon connection.

The computer terminal at the investigation site in particular embodiments may be configured to receive glucose related data from multiple subjects each using a separate analyte monitoring system, and accordingly, may be configured with functionalities to process the received data to maintain data integrity (avoiding data tampering, for example), and secured data transfer to another location or entity such as the investigation or study coordinator or researcher. In a further aspect, the subject may upload the data from the receiver unit 104 to the data processing terminal 105, and thereafter, transmit the collected data electronically (for example, as an electronic mail attachment in .csv or a compatible file format) to the investigation site which may also be optionally encrypted and/or password protected to maintain data security. In yet a further aspect, the data processing terminal 105 may be configured to automatically transmit the uploaded data from the receiver unit 104 electronically to the target investigation site computer terminal as an encrypted zip file (or any other equivalent file format including, for example, password protected, compressed file format).

Indeed, the data processing functionalities associated with the manipulation of the collected glucose related data may be programmed at the computer terminal of the investigation site or the data processing terminal 105 of the analyte monitoring system 100 used by the subject to be automated so as to be automatically executed upon data upload, for example, or alternatively, configured to prompt the subject for further processing including data transmission, storage in a external media such as a CDROM or a writable DVD, a flash memory drive, and the like. Additionally, multiple processes or routines may be configured to simultaneously execute during an open session of the software residing in the computer terminal at the investigation site or the data processing terminal 105 configured for data processing and analysis.

In one aspect, prior to the commencement of the investigation or study, each receiver unit 104 (FIG. 1) may be programmed or configured to the specific needs of the particular study or investigation. For example, in one aspect, through the user interface of the computer terminal at the investigation site connected to the receiver unit 104, the receiver unit 104 may be configured to select the rate of glucose data acquisition and/or logging or storing (for example, once per minute, once every two minutes, once every five minutes). Such data acquisition (logging or storing) rate programmable to the receiver unit 104 via the computer terminal at the investigation site may allow the investigation to define the amount of data to be collected based on the frequency of the data acquisition, for example. Accordingly, in one aspect, the receiver unit 104 may be configured to store glucose related data at the customized or specified data rate and stored in one or more of its memory during the investigation or study time period.

In another aspect, the display or output component of the receiver unit 104 may be disabled or masked to avoid potential interference of the investigation or study by the subject's diet, exercise or other behavioral modification based on the data viewed on the receiver unit related to the monitored glucose level. In addition, receiver unit 104 may be configured to disable certain of the functionalities when coupled with the data processing terminal 105 in the analyte monitoring system 100 to mask the collected data to maintain integrity of the investigation or study protocol. Indeed, in certain cases, it may be desirable to disable one or more output functionalities on the receiver unit 104 and/or the data processing terminal 105 such that the information associated with the monitored glucose level does not influence the subject's behavior.

Additionally, when the data from the receiver unit 104 or the data processing terminal 105 is transferred to the computer terminal at the investigation site, in one aspect, a predefined identifier such as a personal identification number (PIN) code may be generated which uniquely identifies the subject and the corresponding investigation site. For example, in one aspect, a PIN code may be generated which is a checksum of the subject and the investigation site identification, and is used to ensure that for data uploads or transfers, the subject and the investigation site identification information are accurately provided so that the information or data is properly attributed and stored to the associated subject and the investigation site. In one embodiment, the PIN code may include a 16-bit Cyclic Redundancy Check (CRC) checksum of concatenation of the investigation site identification (ID) and the subject identification (ID) expressed as a four hexadecimal characters. Within the scope of the present disclosure, the generated PIN code may include other checksum that includes the site ID and the subject ID subsequently used for data verification.

When the data from the receiver unit 104 or the data processing terminal 105 has been uploaded to the computer terminal of at the investigation site, for example, in particular embodiments, a full data log text file may be generated and thereafter subsequently parsed to generate one or more files in a predetermined file format such as, for example, but not limited to .csv, or .txt file format. In one aspect, the generated files may include an event log file that includes recorded or stored events during the subject's use of the analyte monitoring system 100 (FIG. 1) and stored in the receiver unit 104. Examples of stored events may include, for example, but not limited to alarm or alert notifications, frequency of hypoglycemic or hyperglycemic excursions, analyte sensor signal drop out conditions, or receiver unit hardware operating conditions. In one aspect of the present disclosure, the event log file may be parsed into a subset of events based on, for example, level of granted access to the particular investigation site, for example.

In one aspect, another file may be generated that includes a checksum of all individual files collected, generated and/or received, and an encrypted checksum file to verify the integrity of the individual files, where the comparison of the checksum of the files and/or the corresponding encrypted checksum with the individual files resulting in a match returns a verified, unmodified data set.

In one aspect, when files are written to a CDROM, a certificate may be generated which indicates whether the files to be written have been verified as unmodified since the initial upload from the receiver unit 104. Data is verified when uploaded and also, when written onto the CDROM. As such, when data files are generated, in one aspect, a status field may be written to the data header with one or three values—a “0” indicating data verified condition, a “1” indicating that data verification was unable (for example, the checksum is missing), and a “2” indicating that the data was modified (the checksum compared do not match). Additionally, the checksum of the generated file is stored in encrypted format such that it can be confirmed that the file retrieved is identical to the file that was previously stored.

For data in a file confirmed as being unmodified since the initial upload from the receiver unit 104, in one aspect, the data is associated with a status of “0” and has matched the stored checksum. In this manner, a two stage data verification routine is provided to ensure that the collected glucose information from each subject is not altered from the time the collected data is uploaded from the subject's receiver unit, such that the underlying investigation or study is not compromised with introduction of inaccuracies or data modification.

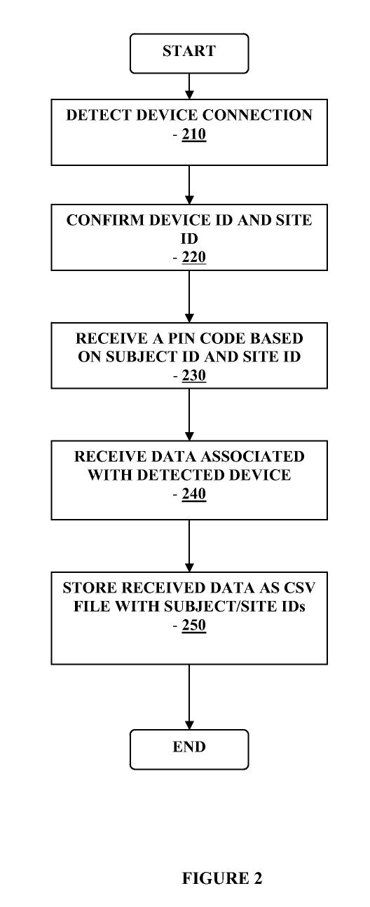

Referring now to FIG. 2, there is shown an example flowchart for data upload routine for use with the overall system of FIG. 1 in accordance with one embodiment of the present disclosure. At the conclusion of the investigation or study, the device or receiver unit 104 (FIG. 1) is coupled to the computer terminal at the investigation site (210). That is, at the conclusion of the study, to import the glucose related data from the receiver unit or device, computer terminal at the investigation site executes a computer program or utility for transferring data from the device or receiver unit to the computer terminal for further data processing and analysis.

Upon detection of the device connection, the device identification (for example, serial number and version information) from the receiver unit or device is confirmed or stored (220). Based on the received or confirmed device ID and the site ID, a menu of available configuration functions for the device may be provided. Further, a previously generated PIN code as described above, for example, by an investigation site administrator which is based on a checksum of the subject and the investigation site identification, may be received (230). Thereafter, the data from the receiver unit or device is received or uploaded to the computer terminal at the investigation site and stored along with the subject and investigation site identification (240). As shown in FIG. 2, the received data is stored as one or more files in a predetermined format such as a .csv format along with the subject and investigation site identification, for example, which may be recalled or retrieved (250).

In this manner, the glucose related data collected by the receiver unit or device from each subject using the analyte monitoring system for the particular investigation or study may be stored in a central location such as the corresponding investigation site for the associated subjects for further processing.

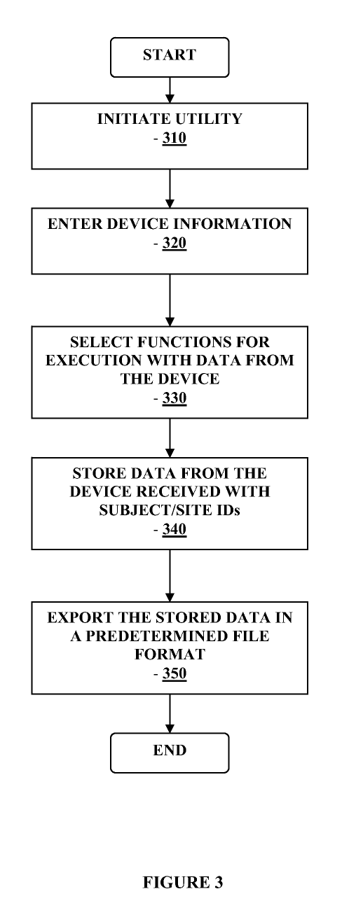

FIG. 3 is an example flowchart for data upload routine for use with the overall system of FIG. 1 in accordance with another embodiment of the present disclosure. Referring to FIG. 3, in one aspect, the data processing utility is initiated when the data upload from the device or receiver unit is desired (310). Using the functionalities of the software utility, the device information or identification is entered (320) and functions associated with the device having the entered identification is called and executed (330). For example, in the case where automatic transfer of the uploaded data file function is configured in the software utility, upon detection of the corresponding device, the function or routine associated with the automatic transfer of the uploaded data file is called for execution upon receipt and verification of the data.

Referring back to FIG. 3, the data received from the device or uploaded from the device is stored with the associated subject and investigation site identification information (340). The stored data may also be associated with an encrypted checksum of the data files from the device. Thereafter, the stored data may be exported (350), for example, written onto a CDROM in a predetermined file format such as in .csv format.

In the manner described, in accordance with the various embodiments of the present disclosure, data processing and communication capabilities are provided that ensure accuracy of data transfer, in particular, when multiple devices are used, collected, and associated with multiple subjects, and multiple investigation locations, including, for example, an indication of whether the glucose data collected from each patient or subject has been modified since data acquisition from the patient, automatic transfer or communication of the acquired data to one or more other locations, and transfer of the collected data onto desired media, in a secure environment.

For example, in one aspect, the investigation site administrators or clinical study administrators may use a PIN code generator which uses the subject identification information and the investigation site identification information and generates a unique PIN code that is based on a CRC of these two values (i.e., subject and site ID). A database including for example, three fields for these three parameters (subject ID, site ID and the generated PIN code) may be shared or distributed with the site or clinical study administrators. Thus, in one aspect, for data uploads from the device, the administrator may be required to enter the corresponding subject ID, the site ID and the PIN code.

The PIN code in this manner may be configured to ensure that the subject ID and the site ID entered or provided by the administrator is accurately provided at the time of data upload from the device to the computer terminal at the investigation site. For example, if the subject ID was entered incorrectly (e.g., 1234567890 instead of 2345678901), the associated PIN code would not match and the operator/administrator would be notified of such mismatch. The correct subject ID and the site ID are then used to generate the names of the data folder and files where the uploaded data is to be stored in the computer terminal. In one aspect, the subject ID and the site ID may be also added to the header information included in a subset of the stored data files

In a further aspect, the uploaded data from the device may be stored on the computer terminal at the investigation site, for example, and parsed into individual files such as glucose data file, event log file, and so on. When the parsed files are generated, in one aspect, a character may be added to the file header indicating that the files were verified (for example, associated with a status “0”). After adding the character indicating the verification status, a text file may be generated that includes the checksum (CRC, for example) for each of the individual files generated. Thereafter, a second copy of this file is generated, encrypted and stored (for example, as a .bin file).

In this manner, the text file generated may be viewed or accessed by administrators or users with the checksum information of the individual raw or parsed data files, and verify that the data has not been modified since the data upload from the device. On the other hand, .bin file generated, encrypted and stored may be retrieved or accessed by one or more of the software utility functions, for example, residing in the computer terminal at the investigation site. At the time of data transfer, export or upload, checksums for all the files in the database (or directory structure) storing the data files (or alternatively, of only those files selected for export from a directory structure) may be recalculated and to the checksums in the encrypted and stored files (for example, the .bin files). In one aspect, a certificate may be generated at the time of data export which indicates whether the files have been verified (e.g., checksums match), or modified (e.g., checksums do not match). In certain circumstances, data files may be not verified since the initial upload from the device because the original encrypted file (.bin file) is no logger present. In this case, such files may be marked or flagged on the generated certificate as not verified. For example, data files that are either modified or not verified may also be associated with a respective indicator (character 2 and 1, respectively) which may be embedded in the header of the parsed files. In this manner, during data export, the encrypted .bin file and the character from the data file header are read and flagged as verified if both the checksum matches and the verified identifier (for example, the “0” character) is located in the header.

Accordingly, a method in one embodiment includes detecting a device connection, receiving device identification information (for example, automatically transmitted from the device upon establishing communication) and subject and/or location information associated with the device (which may be either entered by the device operator or automatically loaded from a database based upon the received device identification information and then confirmed by the operator), providing a code for example, a PIN code previously provided to the operator of the device by an administrator with password enabled access to a PIN code generator included in the software, based on the subject identification information and the location information (for example, the investigation site information), along with the subject and the location/investigation site identification or information, receiving glucose data over the detected device connection, and storing the received glucose data with the subject and the investigation site/location information in a predetermined file format.

The location information may include an investigation site and/or relevant clinical study information for example, study phase, treatment group, and the like.

The generated code may include a personal identification number (PIN).

In particular embodiments, the generated code may include a checksum, where the checksum may include a cyclic redundancy check (CRC) checksum.

The generated code in one aspect may include a concatenation of the device identification information and the location information.

In a further aspect, the predetermined file format may include CSV format.

The method in still another aspect may include exporting the stored glucose data with the subject and location identification information in the predetermined file format, where exporting the stored glucose data may include writing the glucose (and other) data with the subject and location identification information onto a media device, and further, where the media device may include one or more of a CDROM, a zip drive, a flash memory device, or a writable DVD, along with a checksum. In one aspect, the verification certificate may be provided onto the media device.

In yet another aspect, the method may include encrypting the generated checksum, where the encrypted generated checksum may be stored with the received glucose data with the generated checksum.

In a further aspect, there may be two sets of generated codes—one CRC checksum for each subject's subject/site ID and one CRC checksum for each generated data file.

In still another aspect, the method may include decrypting the encrypted generated checksum, and comparing the decrypted generated checksum to the stored received glucose data.

When the compared decrypted generated code does not match the stored received glucose data, the method in another aspect may include declaring stored received glucose data as not verified.

In one aspect, the header information associated with the data may include the verification status of the corresponding data file.

In still another aspect, the subject/site ID may be used to generate names of files and directory structures or folders.

An apparatus in accordance with another aspect includes a data communication interface, one or more processors coupled to the data communication interface, and a memory storing instructions which, when executed by the one or more processors, detects a device connection, receives device identification information associated with the device, generates/receives a code based on the subject and investigation site location information, receives glucose data over the detected device connection, stores the received glucose data with the generated code in a predetermined and encrypted file format.

In one aspect, the generated checksum based on the subject and investigation site location information may include a personal identification number (PIN), and further, where the generated code may include a checksum that may be a cyclic redundancy check (CRC) checksum.

Moreover, the generated code may include a concatenation of the subject and/or device identification information and the location information.

In the manner described above, in particular embodiments, computer software utility is provides that supports clinical investigations which allows the user or the study coordinator to capture and process glucose related data and customize the analyte monitoring device/system and the data acquisition rate, for example, suitable for the underlying investigation.

The various processes described above including the processes performed by the processor in the data processing terminal or the computer terminal at the investigation site in the software application execution environment as well as any other suitable or similar processing units embodied in the analyte monitoring system 100, including the processes and routines described in conjunction with FIGS. 2-3, may be embodied as computer programs developed using an object oriented language that allows the modeling of complex systems with modular objects to create abstractions that are representative of real world, physical objects and their interrelationships. The software required to carry out the inventive process, which may be stored in a memory (or similar storage devices in the data processing terminal 105 or in the computer terminal at the investigation site) of the processor, may be developed by a person of ordinary skill in the art and may include one or more computer program products.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present disclosure and that structures and methods within the scope of these claims and their equivalents be covered thereby.

What is claimed is:

1 A method, comprising:
detecting a device connection;
receiving device identification information;
receiving a code based on a subject information and the location information;
receiving glucose data over the detected device connection; and
storing the received glucose data with a generated code in a predetermined file format.

2. The method of claim 1 wherein the location information includes an investigation site.

3. The method of claim 1 wherein the generated code includes a personal identification number (PIN).

4. The method of claim 1 wherein the generated code includes a checksum.

5. The method of claim 4 wherein the checksum includes a cyclic redundancy check (CRC) checksum.

6. The method of claim 1 wherein the generated code includes a concatenation of the device and/or subject identification information and a clinical study identifier (such as location) information.

7. The method of claim 1 wherein the predetermined file format includes CSV format.

8. The method of claim 1 including exporting the stored glucose data with the generated code in the predetermined file format.

9. The method of claim 8 wherein exporting the stored glucose data includes writing the glucose data with the generated code onto a media device.

10. The method of claim 9 wherein the media device includes one of a CDROM, a zip drive, a flash memory device, or a writable DVD.

11. The method of claim 1 including encrypting the generated code.

12. The method of claim 11 wherein the encrypted generated code is stored with the received glucose data with the generated code.

13. The method of claim 12 including:
decrypting the encrypted generated code; and
comparing the decrypted generated code to the stored generated code.

14. The method of claim 13 wherein comparing includes verifying the stored received glucose data.

15. The method of claim 13 wherein when the compared decrypted generated code does not match the stored generated code, declaring stored received glucose data as not verified.

16. An apparatus, comprising
a data communication interface;
one or more processors coupled to the data communication interface; and
a memory storing instructions which, when executed by the one or more processors, detects a device connection, receives device identification information, receives a code generated based on the subject identification information and the location information receives glucose data over the detected device connection, and stores the received glucose data with the generated code in a predetermined file format.

17. The apparatus of claim 16 wherein the generated code includes a personal identification number (PIN).

18. The apparatus of claim 16 wherein the generated code includes a checksum.

19. The apparatus of claim 18 wherein the checksum includes a cyclic redundancy check (CRC) checksum.

20. The apparatus of claim 16 wherein the generated code includes a concatenation of the device identification information and the location information.
